(19) United States
(12) Patent Application Publication
(10) Pub. No.: US 2024/0176730 A1
(43) Pub. Date: May 30, 2024

(54) SOFTWARE ERROR STATE RESOLUTION THROUGH TASK AUTOMATION

(71) Applicant: INTERNATIONAL BUSINESS MACHINES CORPORATION, Armonk, NY (US)

(72) Inventors: Melanie DAUBER, Oceanside, NY (US); Jacob Ryan JEPPERSON, St. Paul, MN (US); Zachary A. SILVERSTEIN, Georgetown, TX (US); Jeremy R. FOX, Georgetown, TX (US)

(21) Appl. No.: 18/070,589

(22) Filed: Nov. 29, 2022

(51) Int. Cl. G06F 11/36

(52) U.S. Cl. CPC G06F 11/3692; G06F 11/3688

(57) ABSTRACT

A method includes: saving data logs from a plurality of user devices; creating a knowledge corpus based on the data logs; creating a remediation library based on the knowledge corpus, wherein each entry in the remediation library includes data defining a respective error state from the knowledge corpus and user actions associated with the respective error state; detecting a real time error state in one of the user devices; identifying an entry in the remediation library based on the real time error state in the one of the user devices; and causing the one of the user devices to display a message indicating the actions included in the identified entry in the remediation library.

### BACKGROUND

Aspects of the present invention relate generally to handling error states encountered when using computing devices and, more particularly, to software error state resolution through task automation.

Software running on user computing devices, such as laptop computers, desktop computers, tablet computers, smartphones, and smart televisions, often exhibits error states in which the software does not act as intended. Error states can include, for example, an application not opening or crashing while running. Another example of an error state is video conferencing software not connecting a user correctly, such as connecting the user to a conference with video but no audio, or with audio but no video. Another example of an error state is an application not navigating correctly within areas of the application in response to valid user input. These are but a few examples of error states and do not cover all possible error states.

It is common practice for software developers to release updates or patches to their software to fix known error states. However, software updates and patches are released relatively infrequently (e.g., every few months or less frequently), and users often are stuck dealing with error states in the meantime until a software update or patch is released. Faced with this problem, users sometimes discover workarounds that enable them to avoid an error state and utilize the software in a desired manner. Such workarounds often involve a series of steps performed by the user either inside or outside the application with the error state, and performing these steps enables the user to use the application in a desired fashion without experiencing the error state.

### SUMMARY

In a first aspect of the invention, there is a computer-implemented method including: saving, by a processor set, data logs from a plurality of user devices; creating, by the processor set, a knowledge corpus based on the data logs; creating, by the processor set, a remediation library based on the knowledge corpus, wherein each entry in the remediation library includes data defining a respective error state from the knowledge corpus and user actions associated with the respective error state; detecting, by the processor set, a real time error state in one of the user devices; identifying, by the processor set, an entry in the remediation library based on the real time error state in the one of the user devices; and causing, by the processor set, the one of the user devices to display a message indicating the actions included in the identified entry in the remediation library. In this manner, implementations of the invention provide a quick fix to an error state in real time, wherein the quick fix advantageously permits the user of the user device to ameliorate the error state in real time and without having to wait for a software update or patch.

In embodiments, the method comprises: receiving, by the processor set, feedback from the one of the user devices, wherein the feedback comprises positive feedback or negative feedback about the actions; and revising, by the processor set, the remediation library based on the feedback. In this manner, implementations of the invention provide the benefit of updating the remediation library to promote actions that receive positive feedback and demote actions that receive negative feedback.

In further embodiments, the identifying the entry in the remediation library comprises: determining an entry in the knowledge corpus that is most similar to the real time error state in one of the user devices; and identifying the entry in the remediation library that corresponds to the determined entry in the knowledge corpus. In this manner, implementations of the invention provide the benefit of suggesting actions that are based on a most likely match between the real time error state and the data in the knowledge corpus.

In another aspect of the invention, there is a computer program product including one or more computer readable storage media having program instructions collectively stored on the one or more computer readable storage media. The program instructions are executable to: save data logs from a plurality of user devices; create a knowledge corpus based on the data logs; create a remediation library based on the knowledge corpus, wherein each entry in the remediation library includes data defining a respective error state from the knowledge corpus and user actions associated with the respective error state; detect a real time error state in one of the user devices; identify an entry in the remediation library based on the real time error state in the one of the user devices; and cause the one of the user devices to display a message indicating the actions included in the identified entry in the remediation library.

In another aspect of the invention, there is system including a processor set, one or more computer readable storage media, and program instructions collectively stored on the one or more computer readable storage media. The program instructions are executable to: save data logs from a plurality of user devices; create a knowledge corpus based on the data logs; create a remediation library based on the knowledge corpus, wherein each entry in the remediation library includes data defining a respective error state from the knowledge corpus and user actions associated with the respective error state; detect a real time error state in one of the user devices; identify an entry in the remediation library based on the real time error state in the one of the user devices; and cause the one of the user devices to display a message indicating the actions included in the identified entry in the remediation library.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4 shows a flowchart of an exemplary method in accordance with aspects of the invention.

### DETAILED DESCRIPTION

Aspects of the present invention relate generally to handling error states encountered when using computing devices and, more particularly, to software error state resolution through task automation. Software error states are a technological problem that is unique to computing devices. Aspects of the invention provide a technological solution to this technological problem by building a knowledge corpus of historic error states and user-developed solutions, detecting in real time when a user is experiencing an error state on their computing device, selecting a solution from the knowledge corpus based on parameters of the user's computing device, and applying the solution to the user's computing device. The solution is a technological solution because, in one aspect, it involves analyzing big data using artificial intelligence to build the knowledge corpus. The solution is a technological solution because, in another aspect, it involves a first computing device (e.g., a server) automatically detecting an error state on a second computing device (e.g., a user computing device), and further involves the first computing device applying a solution to the second computing device that changes the functioning of the second computing device (i.e., causes the second device to function in a way that avoids the error state). In this manner, implementations of the invention improve the functioning of the second computing device by causing the second computing device to avoid the error state. In this manner, implementations of the invention also provide an improvement in the technical field if resolving error states in computing devices.

As will be apparent from this disclosure, embodiments of the invention provide a computer implemented method that includes: detecting an error state from a first user device; capturing a task list of user resolution steps that precede a successful error resolution; generating a frequency graph based on user resolution steps; storing common resolution steps in a knowledge corpus; detecting the error state from a second user device; and automatically implementing in the second user device, one or more resolution steps from the knowledge corpus, to resolve the error state of the second user device. The method may further include dynamically configuring the one or more resolution steps to adapt to a specific environment running on the second user device.

As will be apparent from this disclosure, embodiments of the invention provide a computer implemented method that includes: detecting an error state of a user device or software running on a user device; identifying steps the user takes to resolve the error state; and automatically making these steps available to another user experiencing a similar error state on another user device. The method may include detecting an error state on a computing device and capturing a task list of user resolution steps. The method may include generalizing the resolution steps over a series of iterations. The method may include creating a task list for each user based on their specific environment, including hardware, operating system, and application. The method may include capturing a temporal aspect of each action set, including lag and wait time, for use in making an amelioration decision for another user. The method may include feeding the resolution steps into an auto-amelioration module that expedites the speed at an optimal state return.

It should be understood that, to the extent implementations of the invention collect, store, or employ personal information provided by, or obtained from, individuals (for example, a user's application usage on their computing device), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as error state amelioration code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

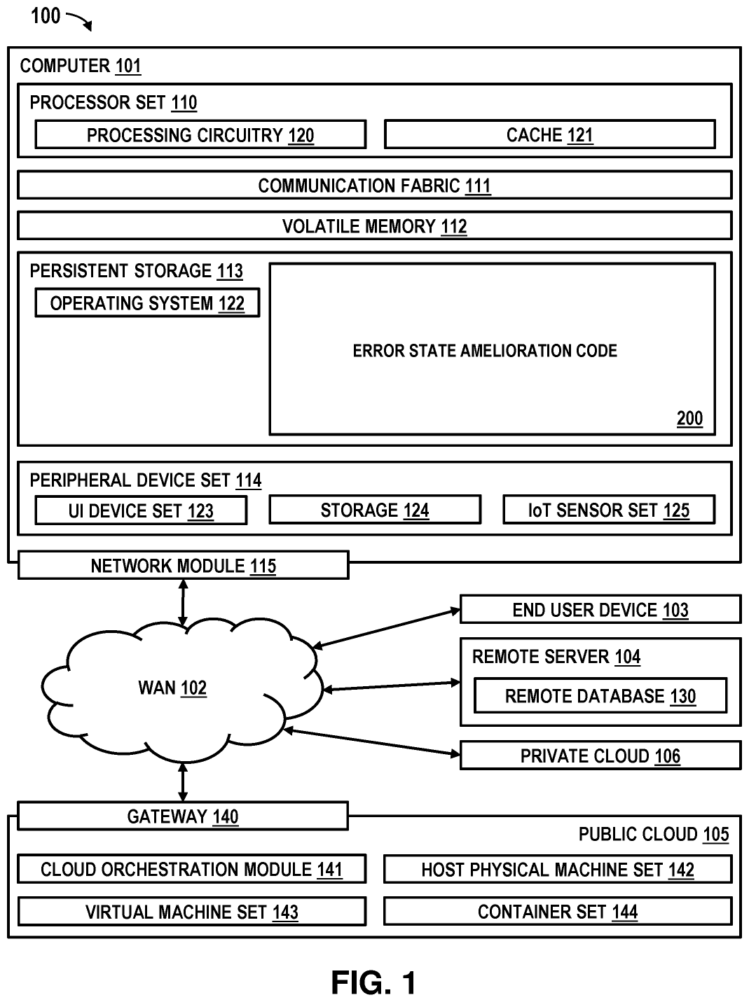

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

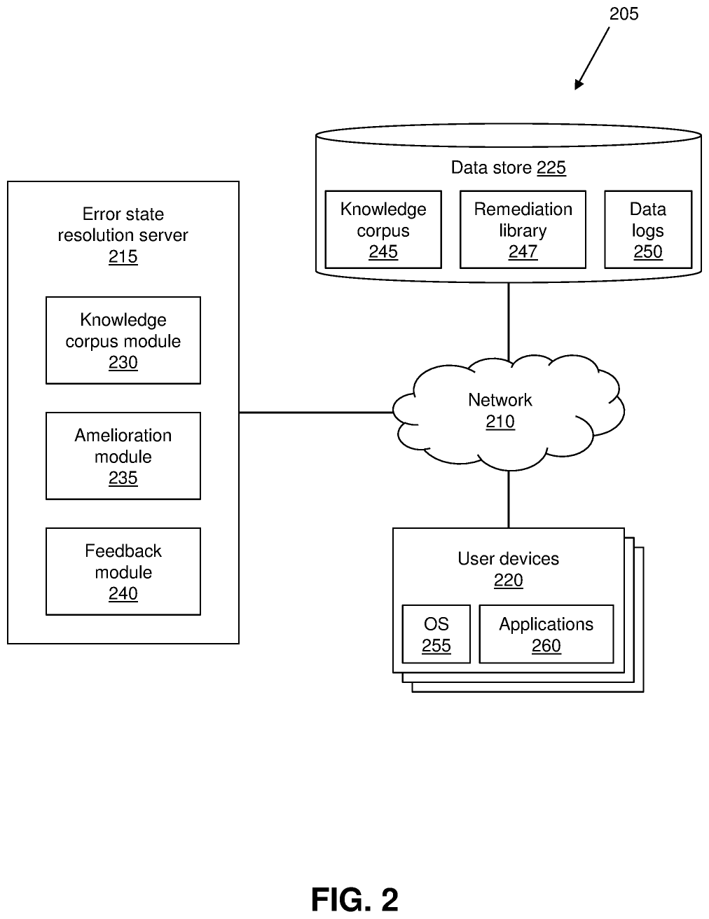

FIG. 2 shows a block diagram of an exemplary environment 205 in accordance with aspects of the invention. In embodiments, the environment includes a network 210 that provides communication between an error state resolution server 215, user devices 220, and data store 225. The error state resolution server 215 of FIG. 2 may correspond to the computer 101 of FIG. 1. In one example, the error state resolution server 215 is implemented using one or more instances of computer 101 of FIG. 1. In another example, the error state resolution server 215 is implemented using one or more virtual machines or containers running on one or more instances of computer 101 of FIG. 1. The network 210 of FIG. 2 may correspond to the WAN 102 of FIG. 1. The user devices 220 of FIG. 2 may correspond to instances of end user device 103 of FIG. 1 and may comprise, for example and without limitation, desktop computers, laptop computers, tablet computers, smartphones, and smart televisions. The data store 225 of FIG. 2 may correspond to storage 124 of FIG. 1.

In embodiments, the error state resolution server 215 comprises a knowledge corpus module 230, an amelioration module 235, and a feedback module 240, each of which may comprise one or more modules of the code of block 200 of FIG. 1. These modules of the code of block 200 are executable by the processing circuitry 120 of FIG. 1 to perform the inventive methods as described herein. The error state resolution server 215 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the knowledge corpus module 230 is configured to create a knowledge corpus 245 that is stored in the data store 225. In embodiments, the knowledge corpus 245 includes data that defines error states detected in the use of user devices 220 and observed resolution steps (also called actions) that users of user devices 220 performed to work around the error states. In embodiments, the knowledge corpus module 230 creates the knowledge corpus 245 by analyzing data logs 250 that include data that defines configurations, events, states, and operations of the user devices 220.

As shown in FIG. 2, each user device 220 may include an operating system (OS) 255 and one or more applications 260. In accordance with aspects of the invention, when a user opts into participation in the inventive method, that user's user device 220 reports data to the data store 225 for storage and analysis. In embodiments, the data reported to data store 225 includes system logs for the OS 255 and application logs for each application 260 for which the user has opted into the method. System logs may include data that defines a record of system events of the OS 255, such as name and version of the OS 255 running on the user device 220, name and version of the user device 220, names and versions of applications 260 that are running on the user device 220 and dates and times the applications 260 that are running, system errors, warnings, startup messages, system changes, abnormal shutdowns, etc. Application logs may include data that defines a record of events that have occurred within a particular one of the applications 260, such as opening an application, closing an application, abnormal shutdown of an application, user data input within the application (e.g., typing in a field of a user interface of the application), sending emails, opening emails, connecting to a videoconference, disconnecting from a videoconference, typing in a chat communication channel of a videoconference, search queries, product views, likes and favorites, shares, make or cancel an order, viewed a page, how much time a user spent looking at a page, how a user scrolled within a page, etc.

In accordance with aspects of the invention, the knowledge corpus module 230 analyzes the data included in the data logs 250 to identify error states that occurred in user devices 220 and to identify actions users performed on their user devices 220 to resolve the error states. As used herein, resolving an error state may include performing actions on the user device 220 after an error state has occurred where the actions ameliorate or eliminate the error state. Resolving an error state may also include performing actions on the user device 220 prior to occurrence of a previously observed error state where the performance of the actions avoids repeating the previously observed error state. Exemplary use cases are described below to illustrate different ways of resolving an error state.

In a first example, a particular version of a videoconferencing application (e.g., one of applications 260) has a bug that causes the videoconferencing application to change configuration settings of the user device 220 to select a particular audio channel of the user device 220 each time the videoconferencing application is started. This unwanted changing of the audio channel of the user device 220 causes an error state for a user that intends to, and was previously using, a different audio channel before they started the videoconferencing application. In this particular example, the user is using their headphones for audio of the user device 220 prior to starting the videoconferencing application. In this example, when the user starts the videoconferencing application, the videoconferencing application changes the audio channel from the headphones to an internal speaker of the user device 220. As a result, the user can see the video stream of the videoconference but cannot hear the audio stream of the videoconference in their headphones. In this example, the user types a message into a chat channel of the videoconference application (e.g., “Please wait . . . I can see you but I cannot hear you”). In this example, the user figures out on their own, or another user mentions in the chat channel, that the user needs to go into their audio configuration settings of the user device 220 and select the headphones as the audio channel. Subsequently, each time this user opens this videoconference application, the user immediately goes into the audio configuration settings of the user device 220 and selects the headphones as the audio channel. This is an example of a user resolving an error state by performing actions on the user device 220 after an error state has occurred, where the actions ameliorate or eliminate the error state.

In another example, a particular version of an email application (e.g., one of the applications 260) has a bug that causes the application to crash when a user drags and drops a file of a particular type (e.g., jpeg) into a draft email. Through observation and trial and error, the user determines that this error state occurs when a particular instant messaging application (e.g., another one of the applications 260) is open on the user device 220 at the same time that the user drags and drops a file of the particular type into a draft email. As a result, the user now proactively closes the instant messaging application before they drag and drop a file of the particular type into a draft email, and in this way the user avoids crashing the email application. This is an example of a user resolving an error state by performing actions on the user device 220 prior to occurrence of a previously observed error state, where the actions cause the user device 220 to avoid repeating the previously observed error state error state.

In embodiments, the knowledge corpus module 230 uses data mining techniques with the data included in the data logs 250 to identify error states that occurred in user devices 220 and to identify actions users performed on their user devices 220 to resolve the error states. Data mining is the process of extracting and discovering patterns in large data sets involving methods at the intersection of machine learning, statistics, and database systems. Data mining involves the automated analysis of large quantities of data to extract previously unknown patterns such as groups of data records (cluster analysis), unusual records (anomaly detection), and dependencies (association rule mining, sequential pattern mining). In a particular exemplary embodiment, the knowledge corpus module 230 uses association rule mining techniques with the data logs 250 to discover error states and related actions preformed to resolve the error states. Association rule learning is a particular type of data mining that searches for relationships between variables in large datasets. In one exemplary implementation, the knowledge corpus module 230 uses association rule mining algorithms that are programmed to look for events that are defined as corresponding to an error state, and to identify user actions associated with those events. Non-limiting examples of events that may be defined as corresponding to an error state include application crashing (e.g., the application closing unexpectedly), application hanging (e.g., the application being unresponsive for a time greater than a predefined amount of time), user comments indicative of a problem (e.g., keyword matching and/or natural language processing of user comments in a communication channel such as a chat sidebar of a videoconferencing application), and the indication of an error in an error log. In this example, the knowledge corpus module 230 is programmed with association rule mining algorithms that are configured to look for these events in the data logs 250, and to identify user actions associated with these events. In this manner, the knowledge corpus module 230 uses data mining techniques (e.g., association rule mining in one particular example) to automatically identify error states and associated user actions in the data logs 250.

The data mining performed by the knowledge corpus module 230 is performed using computing devices executing specialized data mining algorithms, and cannot be done manually (e.g., in the human mind or with pen and paper) due to the amount of data in the data logs 250. Recent estimates indicate that there are about 3.7 billion active users of the two largest smartphone brands in the world. Recent estimates also indicate that one popular videoconference application has 485 million downloads, and another has 39 million registered users. Recent estimates additionally indicate that a popular email application has 1.5 billion users, and another popular email application has 400 million users. Smartphones are only one example of user computing devices 220, which may include other devices such as desktop computers, laptop computers, tablet computers, smart televisions, etc. Videoconferencing applications and email applications are only two examples of thousands of applications 260 that can be implemented on the user devices 220. The data logs 250 can thus contain trillions of lines of data collected from tens of thousands, hundreds of thousands, or even millions of user devices 220 running various OS 255 and applications 260. As a result of such large amounts of data in the data logs 250, there is simply no way that a human could manually perform the data mining described herein.

In embodiments and based on the data mining, the knowledge corpus module 230 stores data defining an identified error state and the actions associated with the error state in the knowledge corpus 245. In embodiments, the knowledge corpus module 230 stores additional information with each identified error state and its associated actions. The additional information may include: hardware description of the user device 220 (e.g., device name, version, model number, etc.); OS 250 name and version running on the user device 220; application 260 name and version associated with the error state; and an identifier of a task being performed in the application 260 when the error state occurred. In embodiments, each respective instance of an identified error state, its associated actions, and its additional information are saved as a respective entry in the knowledge corpus 245.

In embodiments, the knowledge corpus module 230 creates a remediation library 247 based on entries in the knowledge corpus 245. In embodiments, the remediation library 247 includes respective entries, each including an identified error state and the most commonly used actions for that error state (e.g., as determined from a frequency graph for each particular error state). The knowledge corpus 245 may have plural separate entries for a same identified error state, e.g., when plural users have experienced the same error state on their respective user devices 220 and developed their own workarounds. Some user actions for this particular error state may be identical to one another, while other user actions for this error state might be unique. In this situation, the knowledge corpus module 230 creates a frequency graph of the different categories of actions for this particular error state, with instances of the same actions being counted in a same category and instances of different actions being counted in different categories. By creating the frequency graph, the knowledge corpus module 230 determines which category of actions is most commonly used for a particular error state. In embodiments, based on creating the frequency graph for a particular error state, the knowledge corpus module 230 creates an entry in the remediation library 247 to include the particular error state and the actions most commonly performed with this error state as determined from the frequency graph. In embodiments, the entries in the remediation library 247 are linked to their corresponding entries in the knowledge corpus 245. For example, a single entry in the remediation library for a particular error state is linked to the one or more entries in the knowledge corpus that have the same error state and that were used to create the frequency graph for this particular error state. In this manner, the system may use the links to determine correspondence between entries in the remediation library 247 and entries in the knowledge corpus 245. The remediation library 247 may be stored in the data store 225.

With continued reference to FIG. 2, in accordance with aspects of the invention, the amelioration module 235 is configured to detect when a user device 220 is experiencing an error state, to select a set of actions defined in the remediation library 247 based on the detected error state, and to provide the selected actions to the user device 220 experiencing the error state. In embodiments, the module 235 detects an error state of the user device 220 in real time by detecting an event that is defined as corresponding to an error state, such as an application crashing, an application hanging, user comments indicative of a problem, and the indication of an error in an error log, e.g., by monitoring and analyzing real time data obtained from the user device 220. In embodiments, in response to detecting an error state in the user device 220, the amelioration module 235 obtains additional information from the user device 220, wherein the additional information is of the same type as the additional information stored in the knowledge corpus 245 with identified error states (e.g., hardware description of the user device 220; OS 250 name and version running on the user device 220; application 260 name and version associated with the detected error state; and an identifier of a task being performed in the application 260 when the detected error state occurred).

In embodiments, the amelioration module 235 determines respective relevancy scores for respective entries in the knowledge corpus 245 based on the detected error state and additional information from the user device 220. In embodiments, the relevancy score is a quantitative measure of the similarity between (i) an entry in the knowledge corpus including an identified error state and its associated additional information and (ii) the detected error state and its associated additional information. The amelioration module 235 may determine the relevancy score using a similarity scoring algorithm that is specially configured to compare the error state and additional information stored in an entry in the knowledge corpus 245 to the detected error state occurring in real time on the user device 220 and the additional information associated with that detected error state. In embodiments, the amelioration module 235 determines which entry of the knowledge corpus 245 has the highest determined relevancy score for the detected error state at the user device 220, identifies which entry in the remediation library 247 corresponds to the determined highest scoring entry of the knowledge corpus 245, extracts the actions included in the identified entry of the remediation library 247, and provides a message to the user device 220 that suggests performing these actions to attempt to ameliorate the detected error state. In this manner, the amelioration module 235 provides a message to the user device 220 in real time while the user device 220 is experiencing an error state, wherein the message includes suggested actions for the user to perform on the user device 220 to attempt to ameliorate the error state in real time, and wherein the suggested actions included in the message are obtained from an entry in the remediation library 247 based on this entry of the remediation library 247 corresponding to an entry of the knowledge corpus 245 that has a highest measure of similarity to the detected error state.

In accordance with aspects of the invention, the feedback module 240 is configured to receive feedback from the user device 220 after the user performs the actions suggested in the message that was provided by the amelioration module 235. The feedback may be positive (e.g., indicating that the suggested actions ameliorated the error state) or negative (e.g., indicating that the suggested actions did not ameliorate the error state). In embodiments, in response to receiving user feedback for suggested actions, the feedback module 240 adjusts a feedback score associated with the suggested actions for this particular error state. In one example, in response to receiving positive feedback for the suggested actions, the feedback module 240 increments the feedback score of the suggested actions. In another example, in response to receiving negative feedback for the suggested actions, the feedback module 240 decrements the feedback score of the suggested actions.

In embodiments, the system is configured such that a change in the feedback score of the suggested actions can result in the knowledge corpus module 230 revising the entry in the remediation library 247 for this error state. As described above, a single error state may have plural different categories of actions associated with it in the knowledge corpus 245, and the remediation library 247 includes entries that represent a current best choice of one category of actions for each unique error state. In embodiments, the knowledge corpus module 230 determines the current best choice of a category of actions for an error state (to include in the entry in the remediation library 247) by selecting the category of actions that has the highest overall score amongst all the categories of actions for the error state. In embodiments, the overall score for a respective category of actions for an error state is determined using a formula that is based on a feedback score of the category of actions and a frequency graph score of the category of actions. One example of such a formula is the sum of (i) the frequency graph score of the category of actions and (ii) the feedback score of the category of actions multiplied by a weighting factor. In this manner, a first category of actions might initially be used in the remediation library 247 for this error state based on its relatively high frequency graph score. However, this first category of actions might receive a sufficient amount of negative feedback to cause its overall score to drop below the overall score of the next most frequent category of actions for this error state. As a result, the entry for this error state in the remediation library 247 is revised to include the next most frequent category of actions instead of the first category of actions. In this manner, the feedback received from users can cause the system to revise the remediation library 247 that is utilized with subsequent users.

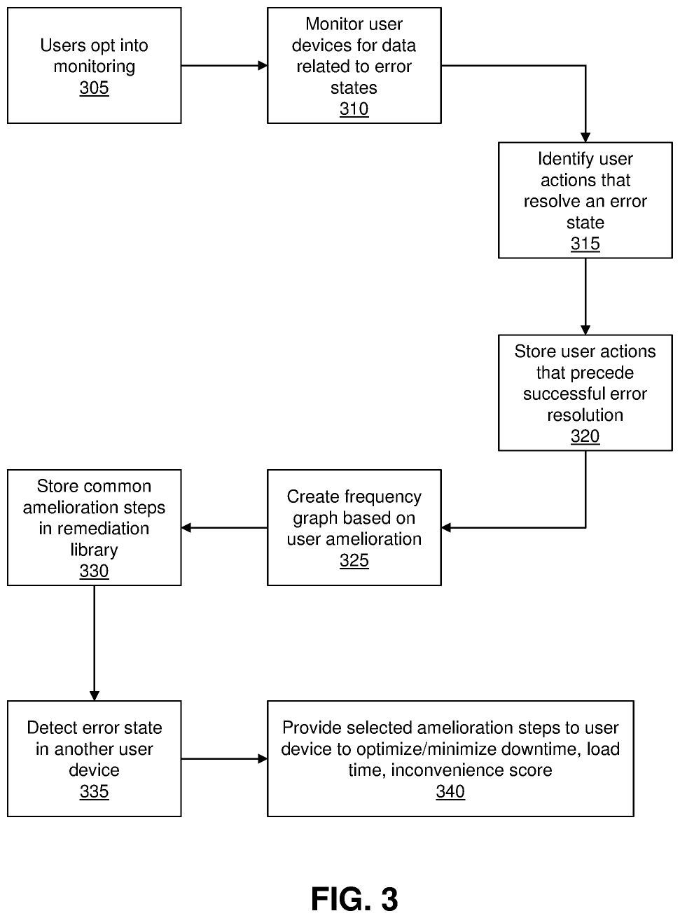

FIG. 3 shows a flowchart of an exemplary method in accordance with aspects of the present invention. Steps of the method may be carried out in the environment of FIG. 2 and are described with reference to elements depicted in FIG. 2.

At step 305, users opt into the system for monitoring data of their user devices 220. In embodiments, during the opt in, users can select which of the applications 260 on their user device 220 they consent for monitoring and which they do not consent for monitoring. In embodiments, during the opting in at step 305 step, the system provides the users with an explanation that they are agreeing to have their actions logged in an effort to aid the building and usage of a reverse engineering knowledge base for shared collaborative solution generation. The explanation may additionally inform the users the further data anonymization will be used to protect their private data and ensure all steps are sanitized for personal information. The opting in step may optionally permits users to agree to monitoring of certain fields of usage and/or areas of expertise to be tracked for software process engineering purposes.

At step 310, the system monitors data on the user devices 220 of users that have consented to the monitoring. In embodiments, the knowledge corpus module 230 obtains relevant data (e.g., logs as described above) from the user devices 220 and stores the data in the data logs 250 of the data store 225. In embodiments, the knowledge corpus module 230 obtains and stores data only for specific ones of the applications 260 that a user has provided consent for monitoring at step 305.

At step 315, the system identifies user actions that resolve an error state. In embodiments, and as described with respect to FIG. 2, the knowledge corpus module 230 uses data mining to identify error states and associated actions in the data of the data logs 250.

At step 320, the system stores user actions that precede a successful error resolution. In embodiments, and as described with respect to FIG. 2, the knowledge corpus module 230 creates an entry in the knowledge corpus 245 for each identified error state and the actions associated with that error state. In embodiments, the entry also includes additional information about the user device 220 that is relevant to the identified error state.

At step 325, the system creates a frequency graph based on user amelioration. In embodiments, the knowledge corpus 245 may have plural separate entries for the same identified error state, e.g., when plural users have experienced the same error state on their respective user devices 220 and developed their own workarounds. Some user actions for this particular error state may be identical to one another, while other user actions might be unique. In this situation, the knowledge corpus module 230 creates a frequency graph of the different categories of actions for this particular error state, with instances of the same actions being counted in a same category of actions and instances of different actions being counted in different categories of actions. By creating the frequency graph, the knowledge corpus module 230 determines which category of actions is most commonly used for this particular error state.

At step 330, the system stores common amelioration steps in a remediation library. In embodiments and as described with respect to FIG. 2, the knowledge corpus module 230 creates a remediation library 247 that includes respective entries each including an identified error state and the most commonly used actions for that error state (as determined from the frequency graph for each particular error state).

In embodiments, steps 310, 315, 320, 325, and 330 constitute building a usage database in the data store 225. In embodiments, these steps are used to observe common situations involving applications 260 on user devices 220 and to catalog common usage of applications 260 on user devices 220 in order to understand the common usage patterns that are both positive and negative for users. This part of the process includes building the overall knowledge corpus of usage so that the system can recognize when a situation (e.g., an error state) is occurring in the future. In embodiments, the monitoring and obtaining of data is performed in the background and does not interfere with the user's primary usage of the user device 220. This allows for the system to be used, taught, and expanded for numerous usages over time. In embodiments, the building of the usage database typically takes place over weeks, months, or even years to be strengthened completely. In embodiments, both positive and negative use cases are built to ensure that a wide variety of actions are monitored, and to ensure that a broader knowledge corpus is built and maintained on a wide array of topics.

At step 335, the system detects an error state in another user device. In embodiments, and as described with respect to FIG. 2, the amelioration module 235 monitors real time data from each of the user devices 220 and detects an error state occurring at a user device 220 based on this data.

At step 340, the system provides selected amelioration steps to the user device 220 (from step 335) to optimize/minimize downtime, load time, and/or an inconvenience score. In embodiments, and as described with respect to FIG. 2, the amelioration module 235 selects an entry from the knowledge corpus 245 based on determined similarity to the detected error state and additional information from the user device 220. The amelioration module 235 then determines which entry of the remediation library 247 corresponds to the selected entry from the knowledge corpus 245. The amelioration module 235 then extracts the actions from the determined entry in the remediation library. The amelioration module 235 then provides a message to the user device 220 wherein the message includes a suggestion to perform the actions extracted from the determined entry from the remediation library 247.

In embodiments, steps 335 and 340 constitute referencing and utilizing the knowledge corpus. As a user is performing their normal actions on the user device 220, they will encounter a problem (e.g., an error state) that requires some sort of action or tasking on their behalf. Identification of the situation (i.e., the error state and the surrounding context) is a first step to successfully supplying the user with a preferred “band-aid” quick fix solution at the present time and interaction. In embodiments, the system performs the following steps to aid within the quick fixes (band-aids) suggestions that the user might try for their particular situation: identify the OS and application the user is using when they encounter the error state; determine if there is a defined task/objective that can be identified that the user is trying to accomplish (e.g., validation request); identify the situation/tasking that the user is trying to perform (e.g., confirmed task identified); refer to the knowledge corpus to determine the vast array of possible remediation paths that have occurred for this specific type of user tasking; and select the best possible “band-aid” solution for the individual to try for their selected situation that is occurring. In embodiments, the selection will be based on (but not limited to), the following criteria: cataloging the user's asset (hardware) of use; the operating system running on the user's asset; the application software in use by the user; objective of task monitoring to be accomplished by the user; both positive and negative actions being taken by user; both positive and negative outcomes for the actions being taken and success/failure thereof; and probability for a potential suggestion match.

In embodiments, the users may provide continual feedback through the ability to call up the feedback module described herein. This allows the user to provide feedback when they are ready, which allows for iterative feedback. Gaining positive and negative feedback is a useful step to enriching the long-term knowledge corpus. For example, understanding negative situations is useful for understanding a possible solution as it is downplayed in importance and priority within future suggestions of other solutions.

An exemplary use case is described here to illustrate aspects of the method of FIG. 3. In the user case, a user tries to join a videoconference using a videoconferencing application (e.g., one of the applications 260) on their user device 220. In this example, the user has trouble connecting to the audio of the videoconference through her user device 220. In this example, the amelioration module 235 detects the error state of the user and generates a pop-up message on the user device 220. The pop-up message gives the user the option to opt in to permitting the system to send her error messages to try short term (“band-aid”) solutions that could potentially solve her problem. The user opts in with the understanding that the system might be able to provide her with short term solutions that were successful for other people with similar problems. In this example, the amelioration module 235 selects a best fit fix (e.g., suggested actions) for the user's detected problem and provides a message to the user device 220 explaining the steps (e.g., actions) the user should perform to implement this fix, with the understanding that the fix is a temporary solution and likely will not resolve the error state in the long term. The user receives the message via their user device 220 and performs the actions indicated in the message. The user then provides feedback to the feedback module 240 indicating whether the suggested actions fixed her error state. The system uses the feedback to improve future recommendations.

In additional embodiments, the system is configured to perform root cause analysis and resolution. In these embodiments, as error states are detected and fixed using suggested actions across plural users, the system uses deep learning models to determine common faults and solutions that identify the root cause of the error state. In these embodiments, based on determining the root cause of an error state, the system identifies a permanent fix for the error state and establishes the permanent fix via a software update or patch. This can be advantageous for preventing future occurrences of the particular error state.

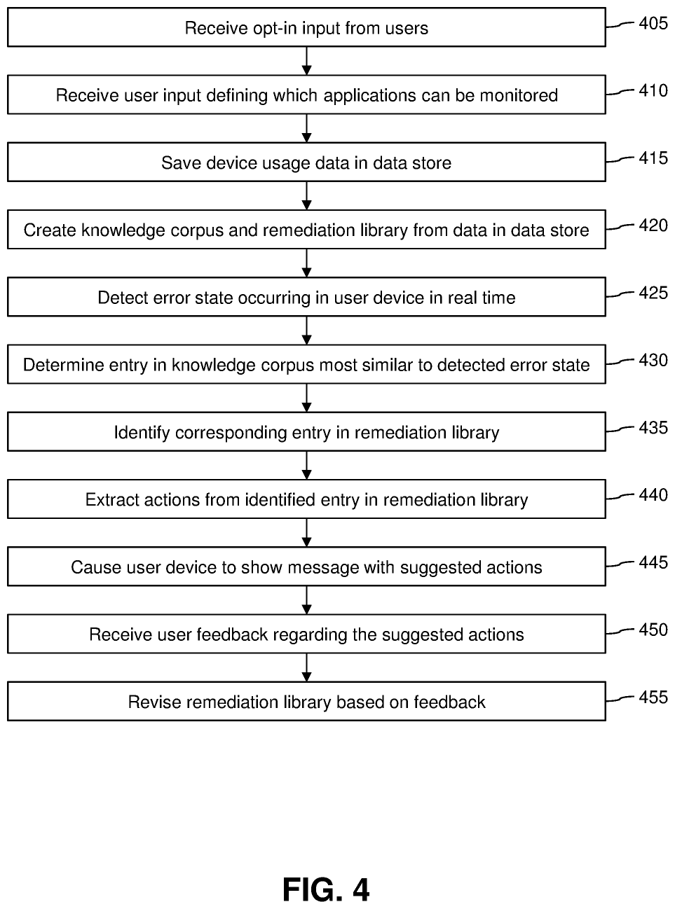

FIG. 4 shows a flowchart of an exemplary method in accordance with aspects of the present invention. Steps of the method may be carried out in the environment of FIG. 2 and are described with reference to elements depicted in FIG. 2.

At step 405, the system receives opt-in input from users. In embodiments, and as described with respect to FIGS. 2 and 3, the error state resolution server 215 receives opt-in input from users via user devices 220.

At step 410, the system receives user input defining which applications can be monitored. In embodiments, and as described with respect to FIGS. 2 and 3, the error state resolution server 215 receives input from users via user devices 220, the input defining which applications 260 the user consents to have monitored as part of the method.

At step 415, the system saves device usage data in a data store. In embodiments, and as described with respect to FIGS. 2 and 3, the knowledge corpus module 230 obtains data about the usage of applications 260 on user devices 220 that were opted in at steps 405 and 410. This data may include, for example, system logs and application logs as described herein. In embodiments, the knowledge corpus module 230 saves the obtained data in data logs 250 of the data store 225. The data can be obtained from tens of thousands, hundreds of thousands, or even millions of user devices 220, resulting in massive amounts of data being saved in the data logs 250. In embodiments, the data saved in the data logs is anonymized to eliminate personal information of the users.

At step 420, the system creates a knowledge corpus and remediation library from data in data store. In embodiments, and as described with respect to FIG. 2, the knowledge corpus module 230 uses data mining (e.g., association rule mining) with the data in the data logs 250 to create a knowledge corpus 245. In embodiments, each entry of the knowledge corpus 245 includes data defining an error state, user actions associated with the error state, and additional information about the context of the error state as described herein. In embodiments, and as described with respect to FIGS. 2 and 3, the knowledge corpus module 230 uses a frequency graph to count frequencies of different categories of actions for same error states in the knowledge corpus 245, and the knowledge corpus module 230 creates a remediation library 247 based on the frequency graph results for each unique error state in the knowledge corpus 245. In embodiments, each entry of the remediation library 247 includes data defining an error state and data defining the most common actions performed to fix this error state.

Steps 405, 410, 415, and 420 may be repeated as new users opt into the system. Steps 415 and 420 may be repeated on a regular basis or as new data becomes available from the user devices 220 being monitored. In this manner, the knowledge corpus 245 and remediation library 247 may be frequently revised based on new data being saved in the data logs 250.

At step 425, the system detects an error state in a user device. In embodiments, and as described with respect to FIGS. 2 and 3, the amelioration module 235 detects an error state in a user device 220, in real time, by monitoring data obtained from the user device 220. In embodiments, in response to detecting an error state, the amelioration module 235 obtains additional information from the user device 220 as described herein.

At step 430, the system determines an entry in the knowledge corpus that is most similar to the detected error state from step 425. In embodiments, and as described with respect to FIGS. 2 and 3, the amelioration module 235 uses a similarity scoring algorithm to determine an entry in the knowledge corpus 245 that is most similar to the detected error state and additional information obtained from step 425.

At step 435, identifies an entry in the remediation library that corresponds to the determined entry of the knowledge corpus from step 430. In embodiments, and as described with respect to FIGS. 2 and 3, the entries in the knowledge corpus 245 are linked to respective entries on the remediation library 247, and the amelioration module 235 uses these links to determine which entry of the remediation library 247 corresponds to the determined entry of the knowledge corpus 245.

At step 440, the system extracts actions from the entry of the remediation library that was identified at step 435. In embodiments, and as described with respect to FIGS. 2 and 3, the amelioration module 235 extracts data defining the actions from the identified entry of the remediation library 247.

At step 445, the system causes the user device to show a message with the suggested actions from step 440. In embodiments, and as described with respect to FIGS. 2 and 3, the amelioration module 235 transmits an instruction to the user device 220 and the instruction causes the user device to display a message (e.g., a pop-up message) that indicates the suggested actions from step 440. The user may then perform the suggested actions on their user device 220 and see if performing the actions ameliorates the error state.

At step 450, the system receives user feedback regarding the suggested actions. In embodiments, and as described with respect to FIGS. 2 and 3, the user may provide input to the user device 220 in the form of positive or negative feedback that indicates whether the suggested actions were successful in ameliorating the error state.

At step 455, the system revises the remediation library based on the feedback received at step 450. In embodiments, and as described with respect to FIGS. 2 and 3, the feedback module adjusts the feedback score of the actions based on the feedback received at step 450, and the knowledge corpus module 230 revises the remediation library 247 based on the adjusted feedback score.

In some implementations, the method includes automatically implementing the suggested actions on the user device 220 experiencing the real time error state. For example, the amelioration module 235 may be configured to receive user approval input in response to the message at step 445. In response to receiving this user approval input, the amelioration module 235 sends instructions to the user device 220 that cause the user device 220 to automatically perform the suggested actions without requiring the user to manually perform the actions.

In some implementations, the method includes dynamically configuring the suggested actions to adapt to a specific environment running on the user device 220 experiencing the real time error state. For example, the suggested actions may be for a same application running on a different operating system. In this example, the amelioration module 235 uses predefined mappings to convert the suggested actions from actions of the first operating system to actions of the second operating system.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
saving, by a processor set, data logs from a plurality of user devices;
creating, by the processor set, a knowledge corpus based on the data logs,
creating, by the processor set, a remediation library based on the knowledge corpus, wherein each entry in the remediation library includes data defining a respective error state from the knowledge corpus and user actions associated with the respective error state;
detecting, by the processor set, a real time error state in one of the user devices;
identifying, by the processor set, an entry in the remediation library based on the real time error state in the one of the user devices; and
causing, by the processor set, the one of the user devices to display a message indicating the actions included in the identified entry in the remediation library.

2. The method of claim 1, further comprising:
receiving, by the processor set, feedback from the one of the user devices, wherein the feedback comprises positive feedback or negative feedback about the actions; and
revising, by the processor set, the remediation library based on the feedback.

3. The method of claim 1, wherein the creating the remediation library comprises:
creating frequency graphs of entries in the knowledge corpus; and
creating the entries in the remediation library based on the frequency graphs.

4. The method of claim 1, wherein the identifying the entry in the remediation library comprises:
determining an entry in the knowledge corpus that is most similar to the real time error state in one of the user devices; and
identifying the entry in the remediation library that corresponds to the determined entry in the knowledge corpus.

5. The method of claim 1, wherein the creating the knowledge corpus comprises identifying error states and user actions associated with the identified error states based on analyzing the data logs.

6. The method of claim 1, further comprising:
identifying a root cause of one of the error states by performing deep learning analysis on the knowledge corpus; and
developing a software update or patch in response to the identifying the root cause of one of the error states.

7. The method of claim 1, further comprising automatically implementing the actions on the one of the user devices.

8. The method of claim 1, further comprising dynamically configuring the actions to adapt to a specific environment running on the one of the user devices.

9. The method of claim 1, further comprising receiving user input opting into the saving the data logs.

10. The method of claim 9, wherein the user input includes consent for monitoring particular applications.

11. A computer program product comprising one or more computer readable storage media having program instructions collectively stored on the one or more computer readable storage media, the program instructions executable to:
save data logs from a plurality of user devices;
create a knowledge corpus based on the data logs;
create a remediation library based on the knowledge corpus, wherein each entry in the remediation library includes data defining a respective error state from the knowledge corpus and user actions associated with the respective error state;
detect a real time error state in one of the user devices;
identify an entry in the remediation library based on the real time error state in the one of the user devices; and
cause the one of the user devices to display a message indicating the actions included in the identified entry in the remediation library.

12. The computer program product of claim 11, wherein the program instructions are executable to:
receive feedback from the one of the user devices, wherein the feedback comprises positive feedback or negative feedback about the actions; and
revise the remediation library based on the feedback.

13. The computer program product of claim 11, wherein the creating the remediation library comprises:
creating frequency graphs of entries in the knowledge corpus; and
creating the entries in the remediation library based on the frequency graphs.

14. The computer program product of claim 11, wherein the identifying the entry in the remediation library comprises:
determining an entry in the knowledge corpus that is most similar to the real time error state in one of the user devices; and
identifying the entry in the remediation library that corresponds to the determined entry in the knowledge corpus.

15. The computer program product of claim 11, wherein the creating the knowledge corpus comprises identifying error states and user actions associated with the identified error states by data mining the data logs.

16. A system comprising:
a processor set, one or more computer readable storage media, and program instructions collectively stored on the one or more computer readable storage media, the program instructions executable to:
save data logs from a plurality of user devices;
create a knowledge corpus based on the data logs;
create a remediation library based on the knowledge corpus, wherein each entry in the remediation library includes data defining a respective error state from the knowledge corpus and user actions associated with the respective error state;
detect a real time error state in one of the user devices;
identify an entry in the remediation library based on the real time error state in the one of the user devices; and
cause the one of the user devices to display a message indicating the actions included in the identified entry in the remediation library.

17. The system of claim 16, wherein the program instructions are executable to:
receive feedback from the one of the user devices, wherein the feedback comprises positive feedback or negative feedback about the actions; and
revise the remediation library based on the feedback.

18. The system of claim 16, wherein the creating the remediation library comprises:
creating frequency graphs of entries in the knowledge corpus; and
creating the entries in the remediation library based on the frequency graphs.

19. The system of claim 16, wherein the identifying the entry in the remediation library comprises:
determining an entry in the knowledge corpus that is most similar to the real time error state in one of the user devices; and
identifying the entry in the remediation library that corresponds to the determined entry in the knowledge corpus.

20. The system of claim 16, wherein the creating the knowledge corpus comprises identifying error states and user actions associated with the identified error states by data mining the data logs.
